(19) United States
(12) Patent Application Publication
(10) Pub. No.: US 2017/0234772 A1
(43) Pub. Date: Aug. 17, 2017

(54) OPTICAL IMAGING SYSTEM FOR INSPECTING TURBINE ENGINE COMPONENTS AND METHOD FOR OPERATING SAME

(71) Applicant: General Electric Company, Schenectady, NY (US)

(72) Inventors: Nirm Velumylum Nirmalan, Liberty Township, OH (US); Jeremy Clyde Bailey, Liberty Township, OH (US); Mohamed Sakami, West Chester, OH (US); David Lance Pennekamp, Hamilton, OH (US); Brian Charles French, West Chester, OH (US)

(21) Appl. No.: 15/043,509

(22) Filed: Feb. 13, 2016

(51) Int. Cl. G01M 15/14; G01J 1/42; G01J 1/04; F02C 3/04; G01J 5/08

(52) U.S. Cl. CPC G01M 15/14; F02C 3/04; G01J 5/0806; G01J 1/0411; G01J 1/4228; G01J 2005/0077

(57) ABSTRACT

A turbine engine having an optical imaging system with a housing configured for mounting to a wall of the turbine engine, a camera located in the housing, a hollow probe extending from the housing and having a longitudinal axis, an image receiving device at an end of the hollow probe and communicably coupled with the camera, and method for operating same.

### BACKGROUND OF THE INVENTION

Turbine engines, and particularly gas or combustion turbine engines, are rotary engines that extract energy from a flow of combusted gases passing through the engine onto a multitude of turbine blades. Gas turbine engines have been used for land and nautical locomotion and power generation, but are most commonly used for aeronautical applications such as for aircraft, including helicopters. In aircraft, gas turbine engines are used for propulsion of the aircraft. In terrestrial applications, turbine engines are often used for power generation.

Gas turbine engines for aircraft are designed to operate at high temperatures to maximize engine efficiency. Temperatures in the high pressure turbine are around 1000° C. to 2000° C. and fluid from the compressor is around 500° C. to 760° C. Internal components of gas and steam turbines, for example, steam turbine blades are typically visually inspected, during a turbine outage, by inserting a borescope through an opening in the outer turbine shell and articulating the video head of the borescope to achieve the desired inspection view. Typically a waiting period is necessary after shutdown and before inspection because current borescope inspection equipment has a temperature limit of approximately 50° C. As a result of this temperature limitation, gas and steam turbine inspections cannot be performed until the turbine cools down from its normal operating temperature.

### BRIEF DESCRIPTION OF THE INVENTION

In one aspect, the invention relates to an optical imaging system, including a housing configured for mounting to a wall of a turbine engine, a camera located in the housing, a hollow probe extending from the housing and having a longitudinal axis, an image receiving device at an end of the hollow probe and communicably coupled with the camera; and at least one mechanism coupled with the housing and configured to urge the hollow probe to move along the longitudinal axis and rotate the hollow probe about the longitudinal axis.

In another aspect, the invention relates to a gas turbine engine, including a radial wall defining an interior and an exterior of the gas turbine engine and having an aperture, a set of turbine blades located in the interior and configured to rotate about a shaft, and an optical imaging system having a housing configured for mounting to the radial wall, a camera located in the housing, a hollow probe extending from the housing and having a longitudinal axis, an image receiving device at an end of the hollow probe in communication with the camera, and at least one mechanism coupled with the housing and configured to urge the hollow probe to move along the longitudinal axis through the aperture into the interior of the gas turbine engine, and configured to rotate the hollow probe about the longitudinal axis.

In yet another aspect, the invention relates to a method for operating an optical imaging system in a gas turbine engine having a rotating set of turbine blades. The method including moving an image receiving device, which is in communication with the camera, into an interior of an operating gas turbine engine, selecting a sampling frequency for imaging based at least in part on a rotational speed of the rotating set of turbine blades, and capturing a set of images of a target visually in-line with the rotating set of turbine blades.

### BRIEF DESCRIPTION OF THE DRAWINGS

In the drawings:

FIG. 1 is a schematic cross-sectional diagram of a gas turbine engine for an aircraft.

FIG. 2 is a block diagram illustrating an optical imaging system in accordance with various aspects described herein.

FIGS. 3a and 3b are perspective views illustrating movement of a probe of the optical imaging system of FIG. 2.

FIG. 4 is a flowchart illustrating a method of operating the optical imaging system of FIG. 2 in accordance with various aspects described herein.

### DESCRIPTION OF EMBODIMENTS OF THE INVENTION

The various aspects described herein relate to an optical imaging system such as a borescope assembly and method for inspecting internal components of a turbine engine while the turbine engine is being operated. Installing optics to monitor and image hot gas path components such as airfoils and combustors, in an operating gas turbine is not a relatively easy or straight-forward task. Presently, rigid optics transmit light with higher imaging fidelity than fiber optics and thus rigid optics can be located inside a gas turbine to relay images to a convenient location where an imaging device such as an infrared (IR) camera can be placed. However, to image its interior with a fixed optics probe, an engine has to be shut down. The various aspects described herein relate to an optical imaging system with a traversing and yawing optics probe such that, while a gas turbine is operating, different regions of the hot gas path can be viewed by remotely moving the probe. The various aspects described herein improve the efficiency in testing and allow more regions to be viewed. Further, the various aspects described herein can be particularly useful in viewing a shroud above a set of rotating turbine blades in a gas turbine engine.

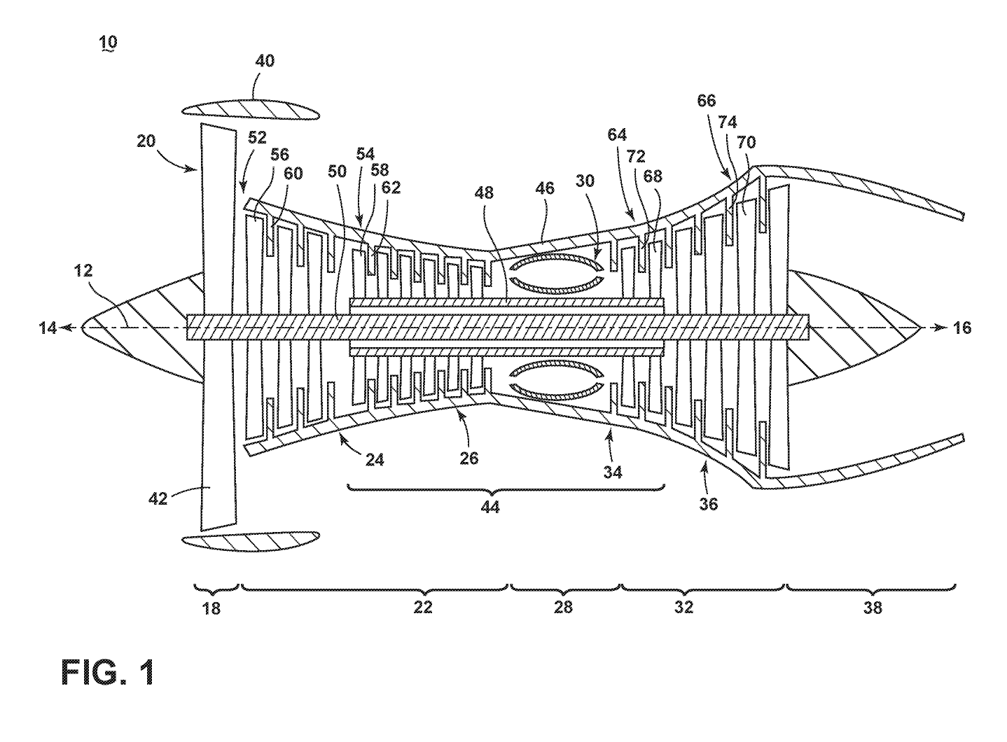

For purposes of illustration, the present invention will be described with respect to an aircraft gas turbine engine. It will be understood, however, that the invention is not so limited and may have general applicability in non-aircraft applications, such as other mobile applications and non-mobile industrial, commercial, and residential applications. FIG. 1 is a schematic cross-sectional diagram of a conventional gas turbine engine 10 for an aircraft in which an optical imaging system described herein can operate. The engine 10 has a generally longitudinally extending axis or centerline 12 extending forward 14 to aft 16. The engine 10 includes, in downstream serial flow relationship, a fan section 18 including a fan 20, a compressor section 22 including a booster or low pressure (LP) compressor 24 and a high pressure (HP) compressor 26, a combustion section 28 including a combustor 30, a turbine section 32 including a HP turbine 34 and a LP turbine 36, and an exhaust section 38.

The fan section 18 includes a fan casing 40 surrounding the fan 20. The fan 20 includes a plurality of fan blades 42 disposed radially about the centerline 12.

The HP compressor 26, the combustor 30, and the HP turbine 34 form a core 44 of the engine 10 which generates combustion gases. The core 44 is surrounded by core casing 46 which can be coupled with the fan casing 40.

A HP shaft or spool 48 disposed coaxially about the centerline 12 of the engine 10 drivingly connects the HP turbine 34 to the HP compressor 26. A LP shaft or spool 50, which is disposed coaxially about the centerline 12 of the engine 10 within the larger diameter annular HP spool 48, drivingly connects the LP turbine 36 to the LP compressor 24 and fan 20.

The LP compressor 24 and the HP compressor 26 respectively include a plurality of compressor stages 52, 54, in which a set of compressor blades 56, 58 rotate relative to a corresponding set of static compressor vanes 60, 62 (also called a nozzle) to compress or pressurize the stream of fluid passing through the stage. In a single compressor stage 52, 54, multiple compressor blades 56, 58 can be provided in a ring and extend radially outwardly relative to the centerline 12, from a blade platform to a blade tip, while the corresponding static compressor vanes 60, 62 are positioned downstream of and adjacent to the rotating blades 56, 58. It is noted that the number of blades, vanes, and compressor stages shown in FIG. 1 were selected for illustrative purposes only, and that other numbers are possible.

The HP turbine 34 and the LP turbine 36 respectively include a plurality of turbine stages 64, 66, in which a set of turbine blades 68, 70 are rotated relative to a corresponding set of static turbine vanes 72, 74 (also called a nozzle) to extract energy from the stream of fluid passing through the stage. In a single turbine stage 64, 66, multiple turbine blades 68, 70 can be provided in a ring and extend radially outwardly relative to the centerline 12, from a blade platform to a blade tip, while the corresponding static turbine vanes 72, 74 are positioned upstream of and adjacent to the rotating blades 68, 70. It is noted that the number of blades, vanes, and turbine stages shown in FIG. 1 were selected for illustrative purposes only, and that other numbers are possible.

In operation, the rotating fan 20 supplies ambient air to the LP compressor 24, which then supplies pressurized ambient air to the HP compressor 26, which further pressurizes the ambient air. The pressurized air from the HP compressor 26 is mixed with fuel in the combustor 30 and ignited, thereby generating combustion gases. Some work is extracted from these gases by the HP turbine 34, which drives the HP compressor 26. The combustion gases are discharged into the LP turbine 36, which extracts additional work to drive the LP compressor 24, and the exhaust gas is ultimately discharged from the engine 10 via the exhaust section 38. The driving of the LP turbine 36 drives the LP spool 50 to rotate the fan 20 and the LP compressor 24.

Some of the ambient air supplied by the fan 20 can bypass the engine core 44 and be used for cooling of portions, especially hot portions, of the engine 10, and/or used to cool or power other aspects of the aircraft. In the context of a turbine engine, the hot portions of the engine are normally downstream of the combustor 30, especially the turbine section 32, with the HP turbine 34 being the hottest portion as it is directly downstream of the combustion section 28. Other sources of cooling fluid can include, but are not limited to, fluid discharged from the LP compressor 24 or the HP compressor 26.

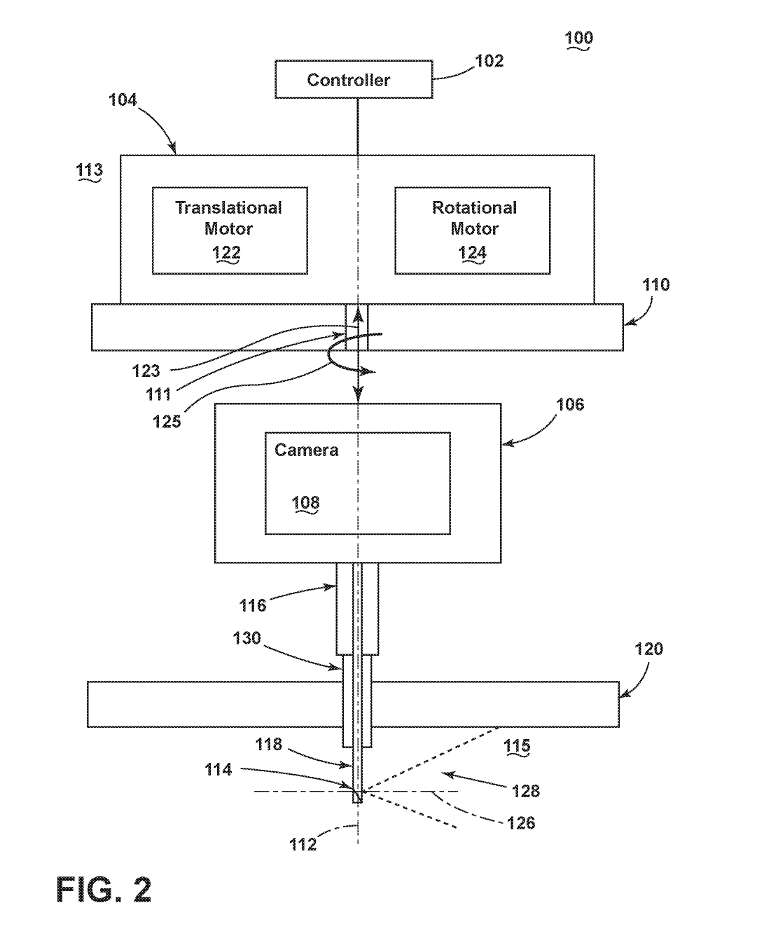

FIG. 2 illustrates more clearly that the core casing 46 (shown in FIG. 1) can include a radial wall 110 that defines an exterior 113 and the interior 115 of the engine 10. At least one aperture 111 can be formed in a portion of the radial wall 110 and is preferably located in proximity to a set of turbine blades 68, 70 (shown in FIG. 1) located in the interior 115 of the engine that are configured to rotate about a rotor. The rotor can be any rotary part of the engine including, but not limited, to the HP spool 48 (shown in FIG. 1) and the LP spool (shown in FIG. 1). The optical imaging system 100 is configured to image at least a portion of the interior 115 of the gas turbine engine 10 while the engine 10 is operating.

Embodiments of the optical imaging system 100 can include a housing 106, a camera 108 located within the housing 106, a hollow probe 118 extending from the housing 108, an image receiving device 114 at the end of the hollow probe 118 and at least one mechanism 104 configured to maneuver the hollow probe 118 within the interior 115 of the gas turbine engine. The housing 106 is included and configured for mounting to the radial wall 110 of the turbine engine. The optical imaging system 100 can be manipulated to directionally control the image receiving device 114, including when inside the gas turbine engine 10. More specifically, at least one mechanism 104 can be coupled with the housing 106 and configured to urge the hollow probe 118 to move along or traverse 123 the longitudinal axis 112 through the aperture 111 into the interior 115 of the gas turbine engine. Further, the urging mechanism can be configured to rotate the hollow probe 118 about the longitudinal axis 112 to induce yaw 125. The urging mechanism 104 can include one or more motors useful for rotating and translating a shaft. For example, as shown, the urging mechanism 104 can include both a translational motor 122 and a rotational motor 124. The urging mechanism 104 can be formed from any device useful for urging or maneuvering the hollow probe 118 along the longitudinal axis 112 into a cavity in the interior 115 of the turbine engine including, but not limited to, one or more permanent magnet stepper motors, hybrid synchronous stepper motors, variable reluctance stepper motors, lavet type stepping motors, AC motors, DC motors, gearboxes, etc. and combinations thereof.

Directional control of the image receiving device 114 is provided by a controller 102 external to the gas turbine engine 10. Thus, the image receiving device 114 is directionally controlled such that a selected one or more components internal to the gas turbine engine 10 can be viewed externally of the gas turbine engine 10. Parts of the optical imaging system 100 can be cooled including, but not limited to, by flowing a cooling medium along a substantial portion of the length of the hollow probe 118 and particularly about the image receiving device 114.

As shown in FIG. 2 the housing 106 indirectly mounts to the radial wall 110 via a coupling along the longitudinal axis 112 to the urging mechanism 104. That is, the urging mechanism 104 directly mounts to the radial wall 110 at the exterior 113 of the turbine engine and the housing 106 is coupled to the urging mechanism through the aperture 111 via a shaft that can traverse 123 and yaw 125 along the longitudinal axis 112. The housing 106 can be mounted to the radial wall 110 through any known mounting method and can include direct mounting to the radial wall 110 and indirect mounting whereby the housing 106 is coupled to additional components that are mounted to the radial wall 110. The housing 106 can be made of any material suitable for protecting the housed camera 108 from high temperatures and pressures associated with gas turbine engines including, but not limited to, stainless steel, aluminum, titanium, etc.

Contained within the housing 106, the camera 108 is responsive to imaging data of one or more components of a turbine engine positioned within a field of view 128 of the image receiving device 114. The camera 108 is configured to sense a temperature of a surface in the cavity or interior 115 of the turbine engine The camera 108 can be any device for recording image data correlated to surface temperatures including, but not limited to, an infrared camera, a visible camera, a pyrometer, a multi-spectral camera, a hyperspectral camera, a charge-coupled device, an active pixel sensor, a complementary metal-oxide-semiconductor (CMOS) sensor, etc.

The hollow probe 118, which can also be referred to as a borescope, extends from the housing 106 along the longitudinal axis 112 normal to the radial wall 110 towards the interior 115 of the turbine engine. The hollow probe 118 provides a conduit of optical communication from the image receiving device 114 at the end of the probe 118 to the camera 108 within the housing 106. The hollow probe 118 can include any components used in the transmission of optical data including, but not limited to, free space, one or more lenses, fiber optic cable and combinations thereof.

The image receiving device 114 located at the distal end of the hollow probe 118 redirects incoming optical data to relay along the longitudinal axis 112. As shown in FIG. 2 the image receiving device relays imagery from a field of view 128 along an axis 126 normal to the longitudinal axis to enable the camera 108 to view an image substantially normal to the longitudinal axis 112. The image receiving device 114 can be configured to relay imagery from any suitable field of view 128 and axis for transmission along the longitudinal axis 112 to the camera 108. The image receiving device 114 can include any optical element known for redirecting optical imagery including but not limited to a mirror, a fiber optic, lenses and combinations thereof.

Concentric to the hollow probe 118, one or more guide tubes 116, 130 can protect and assist to maneuver the hollow probe 118. A moving guide tube 116 can traverse and rotate with the camera housing 106 along the longitudinal axis 112. A fixed or stationary guide tube 130 can be fixed to a wall of the turbine engine where the wall can be any interior structure within the turbine engine including, but not limited to, a radial wall that forms the vanes of a turbine stage.

When the hollow probe 118 or borescope is maneuvered to the correct location and yaw angle, the probe optics enable the camera 108 to image the surface of the shroud 120. Advantageously, the camera 108 attached to the traversing and yawing urging mechanism 104 and coupled to the hollow probe 118 allows the shroud 120 to be imaged while the gas turbine engine is operating. The hollow probe along with the guide tubes 116, 130 can include multiple tubes with optical elements and passages for cooling and purging of air.

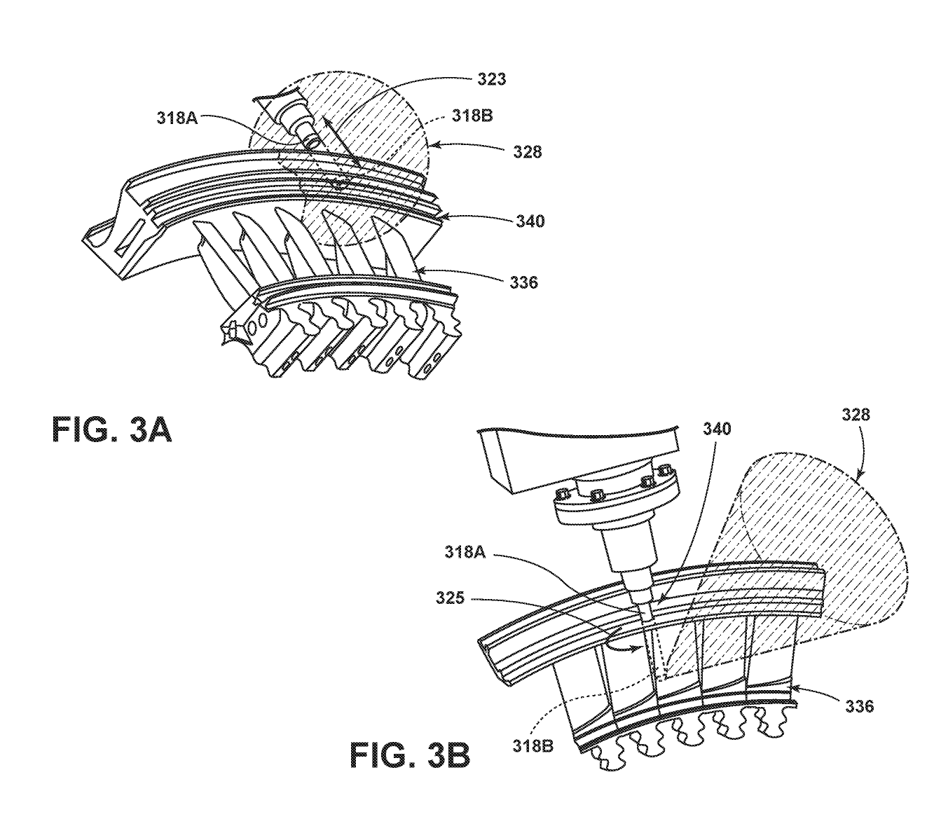

Referring now to FIG. 3a and FIG. 3b, perspective views illustrating movement of the probe 318 of the optical imaging system are shown. Initially in a retracted position, the probe 318A can traverse 323 along its longitudinal axis prior to the camera initiating an imaging sequence. The degree of extension of the probe can depend, in part, on the target of the imaging. That is, imaging the shroud 340 or the set of blades 336 can require the probe to traverse its longitudinal axis some distance between fully retracted 318A and fully extended 318B. Similarly, the optical imaging system can rotate the probe by initiating a yaw 325 about the probe's longitudinal axis. The visual field of view 328 is set by the position and rotation of the probe. Therefore, the optical imaging system initiates traverse 323 and yaw 325 maneuvers to position the probe 318B to place the field of view 328 on elements within the turbine engine such as the shroud 340 and set of blades 336. Consequently, the optical imaging system is configured to visually inspect a set of turbine blades 336 or the shroud 340. Due to the system configuration, the optical imaging system can visually inspect a set of turbine blades 336 as they rotate past the image receiving device at the distal end of the extended hollow probe 318B.

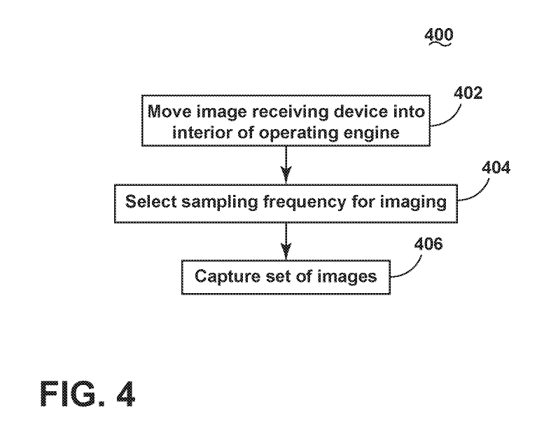

Referring now to FIG. 4, a method 400 for operating a camera in an operating gas turbine engine having a rotating set of turbine blades is shown. To initiate an imaging sequence, an initial step 402 includes a controller signaling the urging mechanism to urge the image receiving device in communication with the camera into the interior of the gas turbine engine. At step 404, based at least in part on the rotational speed of the set of turbine blades, the controller selects a sampling frequency for the imaging. That is the camera will be set to record optical data at specific intervals for predetermined integration times. Akin to imaging behind a picket fence, selecting a sampling frequency can enable the camera to avoid imaging the set of turbine blades and capture a set of images of an inner wall of the gas turbine engine that is visually beyond the set of turbine blades with respect to the image receiving device. That is, the camera can capture images at extremely short integration times such that the blades appear to be stationary and therefore, the camera is able image between the blades at the shroud. Alternatively, the sampling frequency can be selected to enable the camera to exploit aliasing in the set of images such that the set of images captures the same blade or blades in concurrent passes of the blades through the field of view of the camera.

Then, at step 406, the camera captures a set of images of a target visually in-line with the rotating set of turbine blades. The captured set of images can form any set of images of the interior of the turbine engine, including, but not limited to a set of images of the set of turbine blades, a set of thermal images and a set of images of the shroud.

The sequence depicted is for illustrative purposes only and is not meant to limit the method 400 in any way as it is understood that the portions of the method may proceed in a different logical order, additional or intervening portions may be included, or described portions of the method may be divided into multiple portions, without detracting from embodiments of the invention.

Benefits of the above-described embodiments include capturing two-dimensional data related to temperatures of a shroud that are located above a set rotating turbine blades in an operating gas turbine. The shrouds are located in a very high temperature and pressure environment and are proximate to rotating blades moving at very high velocity. The probe is remotely controlled in order that the probe stays in the hot gas path for the minimum time to take the required images thereby preserving the operational life of the optical imaging system components. The optical imaging system provides temperature measurements that are necessary to validate analytical designs and models needed to estimate life of these components.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. An optical imaging system, comprising:
a housing configured for mounting to a wall of a turbine engine;
a camera located in the housing;
a hollow probe extending from the housing and having a longitudinal axis;
an image receiving device at an end of the hollow probe and communicably coupled with the camera; and
at least one mechanism coupled with the housing and configured to urge the hollow probe to move along the longitudinal axis and rotate the hollow probe about the longitudinal axis.

2. The optical imaging system of claim 1 wherein the camera is an infrared camera.

3. The optical imaging system of claim 1 wherein the camera is a pyrometer camera.

4. The optical imaging system of claim 1 wherein the at least one mechanism is configured to urge the hollow probe along the longitudinal axis into an interior of the turbine engine.

5. The optical imaging system of claim 4 wherein the camera is configured to sense a temperature of a surface in an interior of the turbine engine.

6. The optical imaging system of claim 4 wherein the camera is configured to visually inspect a set of turbine blades.

7. The optical imaging system of claim 6 wherein the camera is configured to visually inspect a set of turbine blades as the set of turbine blades rotate past the image receiving device.

8. The optical imaging system of claim 1 wherein the longitudinal axis is normal to the wall of the turbine engine.

9. The optical imaging system of claim 1 wherein the image receiving device includes at least one of a lens or mirror.

10. The optical imaging system of claim 9 wherein the image receiving device is configured to enable the camera to view an image substantially normal to the longitudinal axis.

11. The optical imaging system of claim 1 wherein the at least one mechanism includes at least one of a translating motor or a rotational motor.

12. The optical imaging system of claim 11, further comprising a camera housing and a moving guide tube concentric to the hollow probe, and wherein the at least one mechanism is configured to urge the camera housing and the moving guide tube along the longitudinal axis, and is configured to rotate the camera housing and the moving guide tube about the longitudinal axis.

13. The optical imaging system of claim 1 further comprising a guide tube fixed to the wall of the turbine engine, wherein the hollow probe moves relative to the guide tube.

14. A turbine engine, comprising:
a radial wall defining an interior and an exterior of the turbine engine and having an aperture;
a set of turbine blades located in the interior and configured to rotate about a shaft; and
an optical imaging system comprising:
a housing configured for mounting to the radial wall;
a camera located in the housing;
a hollow probe extending from the housing and having a longitudinal axis;
an image receiving device at an end of the hollow probe in communication with the camera; and
at least one mechanism coupled with the housing and configured to urge the hollow probe to move along the longitudinal axis through the aperture into the interior of the turbine engine, and configured to rotate the hollow probe about the longitudinal axis.

15. The turbine engine of claim 14, wherein the optical imaging system is configured to image at least a portion of the interior of the turbine engine.

16. The turbine engine of claim 15, wherein the optical imaging system is configured to image at least a portion of the interior of the turbine engine while the turbine engine is operating.

17. A method for operating an optical imaging system in a turbine engine having a rotating set of turbine blades, the method comprising:
moving an image receiving device, which is in communication with the camera, into an interior of an operating turbine engine;
selecting a sampling frequency for imaging based at least in part on a rotational speed of the rotating set of turbine blades; and
capturing a set of images of a target visually in-line with the rotating set of turbine blades.

18. The method of claim 17, wherein the capturing the set of images includes capturing a set of images of the set of turbine blades.

19. The method of claim 17, wherein the selecting the sampling frequency includes selecting a sampling frequency to avoid imaging the set of turbine blades and the capturing the set of images includes capturing a set of images of an inner wall of the turbine engine visually beyond the set of turbine blades.

20. The method of claim 17 wherein the capturing the set of images includes capturing a set of thermal images.
